(19) United States
(12) Patent Application Publication
(10) Pub. No.: US 2026/0323011 A1
(43) Pub. Date: Oct. 15, 2026

(54) ENTROPY CODING OPTIMIZATION FOR OPTICAL FLOW MODE AND SECONDARY TRANSFORM

(71) Applicant: Tencent America LLC, Palo Alto, CA (US)

(72) Inventors: Qingyang ZHOU, Palo Alto, CA (US); Liang ZHAO, Palo Alto, CA (US); Tianqi LIU, Palo Alto, CA (US); Madhu PERINGASSERY KRISHNAN, Palo Alto, CA (US); Shan LIU, Palo Alto, CA (US)

(21) Appl. No.: 19/325,352

(22) Filed: Sep. 10, 2025

Related U.S. Application Data
(60) Provisional application No. 63/789,128, filed on Apr. 15, 2025.

(51) Int. Cl. H04N 19/109; H04N 19/13; H04N 19/139; H04N 19/176; H04N 19/184; H04N 19/52; H04N 19/60

(52) U.S. Cl. CPC H04N 19/109; H04N 19/13; H04N 19/139; H04N 19/176; H04N 19/184; H04N 19/52; H04N 19/60

(57) ABSTRACT

An example method of video decoding includes receiving a video bitstream comprising a plurality of blocks, including a current block coded in one of a plurality of compound inter prediction modes. The method also includes selecting a context for decoding an optical flow flag for the current block based on which compound inter prediction mode of the plurality of compound inter prediction modes is used for the current block. The method further includes entropy-decoding the optical flow flag using the selected context, and selectively applying an optical flow refinement to the current block according to the optical flow flag. Instructions for the example method may be stored in a computer system or storage medium.

### RELATED APPLICATIONS

This application claims priority to U.S. Provisional Patent Application No. 63/789,128 entitled “Entropy Coding Optimization for Optical Flow Mode and Secondary Transform,” filed Apr. 15, 2025, which is hereby incorporated by reference in its entirety.

### TECHNICAL FIELD

The disclosed embodiments relate generally to video coding, including but not limited to systems and methods for entropy coding video data.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

The present disclosure describes a set of methods for video (image) compression, including methods of reducing the number of contexts needed for entropy coding. For example, the context for signaling an optical flow mode flag (OPFL mode flag) may depend on the inter compound mode of a current block. As a specific example, if the compound inter mode of the current block uses NEAR_NEARMV, a first context is used to signal the use OPFL mode flag, and if the compound inter mode of the current block uses a different mode, another context is used to signal the use OPFL mode flag. In this way, the context selection may be reduced (e.g., from 4+ contexts down to 2 contexts). Reducing the number of contexts reduces memory requirements for encoding and decoding.

In accordance with some embodiments, a method of video decoding includes (i) receiving a video bitstream (e.g., a coded video sequence) comprising a plurality of blocks, including a current block coded in one of a plurality of compound inter prediction modes; (ii) selecting a context for decoding an optical flow flag for the current block based on which compound inter prediction mode of the plurality of compound inter prediction modes is used for the current block; (iii) entropy-decoding the optical flow flag using the selected context; and (iv) selectively applying an optical flow refinement to the current block according to the optical flow flag.

In accordance with some embodiments, a method of video encoding includes (i) receiving video data (e.g., a source video sequence) comprising a plurality of blocks, including a current block to be coded in one of a plurality of compound inter prediction modes; (ii) setting an optical flow flag based on whether an optical flow refinement is to be applied to the current block; (iii) selecting a context for encoding the optical flow flag for the current block based on which compound inter prediction mode of the plurality of compound inter prediction modes is used for the current block; and (iv) entropy-encoding the optical flow flag using the selected context.

In accordance with some embodiments, a method of video decoding includes (i) receiving a video bitstream (e.g., a coded video sequence) comprising a plurality of blocks, including a current block and a corresponding current transform block; (ii) selecting a context for decoding a secondary transform kernel for the current transform block, wherein the context is based on a size of the current transform block; and (iii) entropy-decoding the secondary transform kernel using the selected context.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding. The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIGS. 4A-4D illustrate example coding tree structures in accordance with some embodiments.

FIGS. 5A-5C illustrate example prediction blocks, residual blocks, and reconstructed blocks according to some embodiments.

FIG. 6 illustrates an example of decoder-side motion vector refinement in accordance with some embodiments.

FIG. 7A illustrates an example video decoding process in accordance with some embodiments.

FIG. 7B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes a set of methods for video (image) compression, including methods for encoding and decoding syntax elements (e.g., for flags and other coded information). As described herein, reducing the number of contexts for encoding/decoding syntax elements has hardware advantages (e.g., reducing the required size of buffers) as well as performance advantages (e.g., reducing the time required to update contexts). As an example, the context management for entropy encoding/decoding an optical flow flag may be simplified by having the context selection being based on the compound inter prediction mode of the current block rather than motion vector information for neighboring/reference blocks. In this way, the number of contexts maintained for the optical flow flag may be reduced from four for more contexts down to two contexts. For example, a context for decoding an optical flow flag for the current block may be selected from a set of contexts based on which compound inter prediction mode of a plurality of compound inter prediction modes is used for the current block.

### Example Systems and Devices

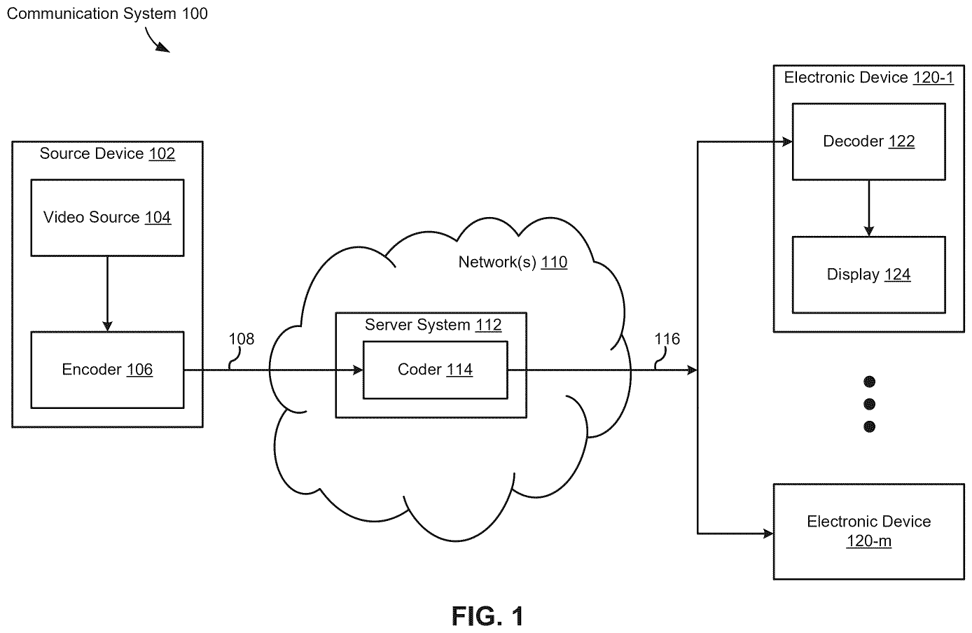

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including, e.g., wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116. In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

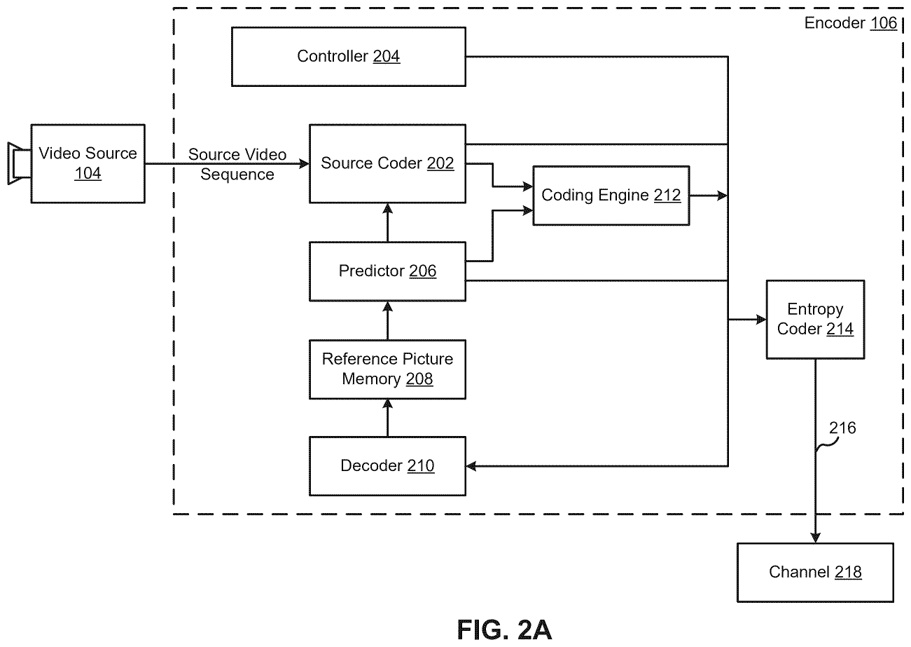

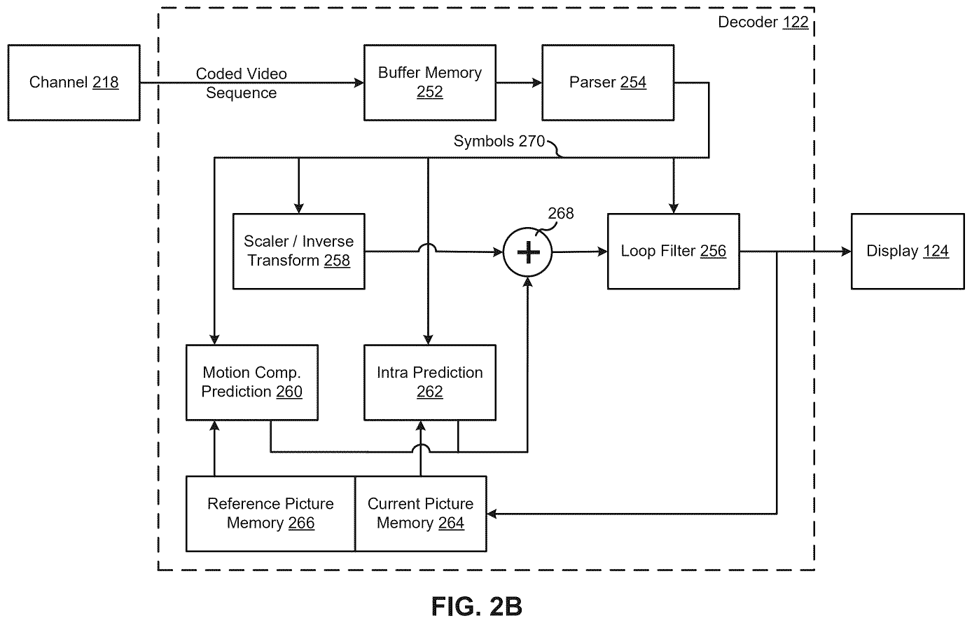

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, e.g., setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (e.g., blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, e.g., coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, e.g., information used to manage operation of the decoder component 122, and/or information to control a rendering device such as the display 124. The control information for the rendering device(s) may be in the form of, e.g., Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, e.g., X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (e.g., by parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. Levels may restrict the maximum picture size, maximum frame rate, maximum reconstruction sample rate (measured in, e.g., megasamples per second), maximum reference picture size, and so on. Limits set by levels may be further restricted through Hypothetical Reference Decoder (HRD) specifications and metadata for HRD buffer management signaled in the coded video sequence.

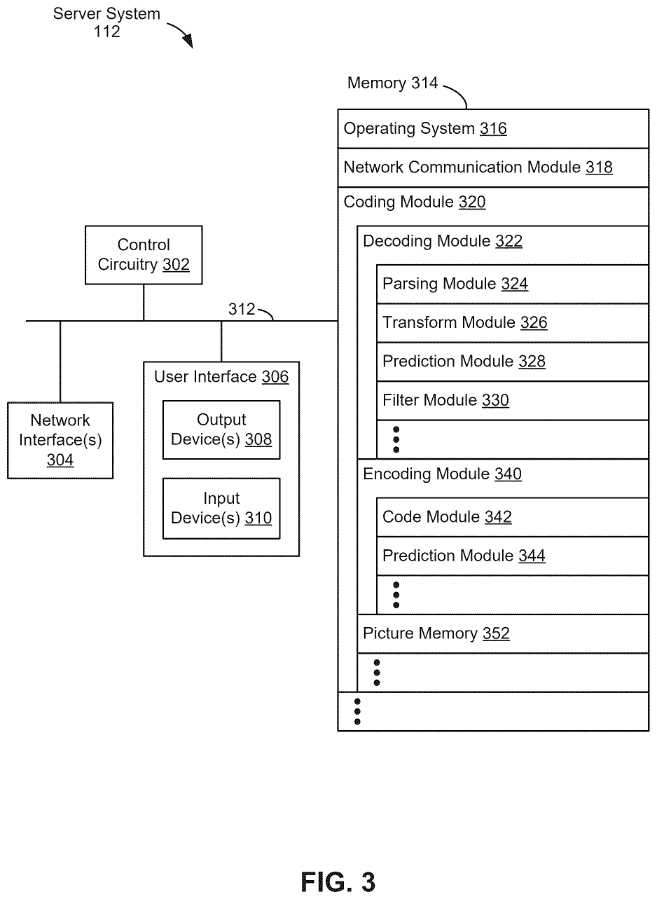

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). As used herein, a block may refer to a coding tree block, the largest coding block, a pre-defined fixed block size, a coding block, a prediction block, a residual block, or a transform block. An inter mode coded block (or inter block) refers to a block using a inter prediction mode or combined intra-inter prediction mode. An intra mode coded block (or intra block) refers to a block using an intra prediction mode or a combined intra-inter prediction mode. An intra mode list may correspond to a list of most probable intra prediction modes for a current block.

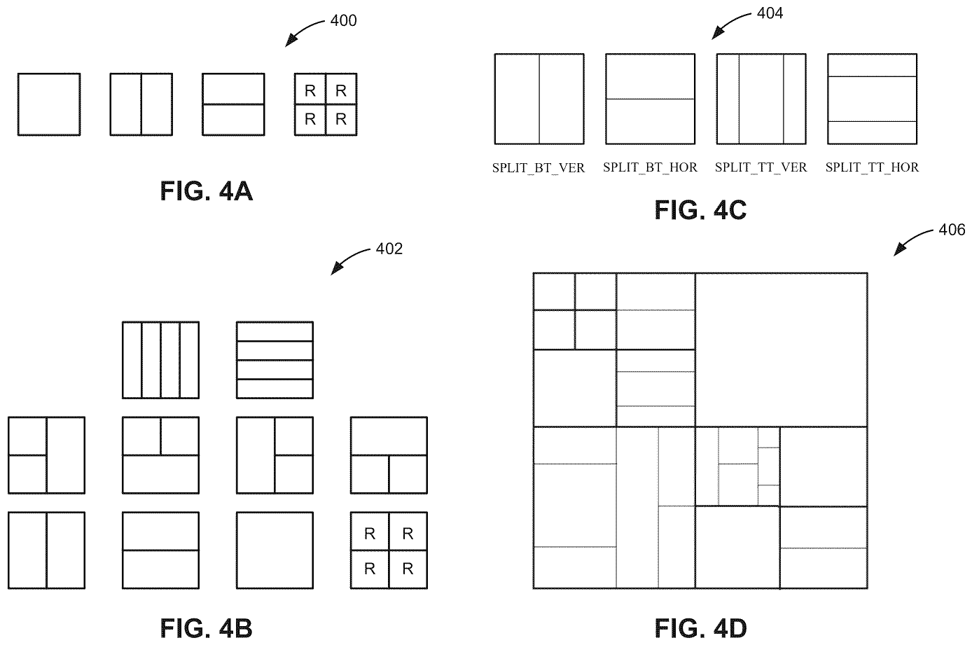

Turning to block partitioning, FIGS. 4A-4D illustrate example coding tree structures in accordance with some embodiments. As shown in a first coding tree structure (400) in FIG. 4A, some coding approaches use a 4-way partition tree starting from a 64×64 level down to a 4×4 level, e.g., with some additional restrictions for blocks 8×8. In FIG. 4A, partitions designated as “R” are recursive in that the same partition tree is repeated at a lower scale until the lowest level is reached. As shown in the example coding tree structure (402) in FIG. 4B, some coding approaches expand the partition tree to a 10-way structure and increase the largest size (e.g., sometimes referred to as a superblock) to start from 128×128. The second coding tree structure includes 4:1/1:4 rectangular partitions that are not in the first coding tree structure. The partition types with 3 sub-partitions in the second row of FIG. 4B are referred to as T-type partitions. In addition to a coding block size, coding tree depth can be defined to indicate the splitting depth from the root note.

As an example, a coding tree unit (CTU) may be split into coding units (CUs) by using a quad-tree structure denoted as a coding tree to adapt to various local characteristics. In some embodiments, the decision on whether to code a picture area using inter-picture (temporal) or intra-picture (spatial) prediction is made at the CU level. Each CU can be further split into one, two, or four prediction units (PUs) according to the PU splitting type. Inside a PU, the same prediction process is applied, and the relevant information may be transmitted to the decoder on a PU basis. After obtaining the residual block by applying the prediction process based on the PU splitting type, a CU can be partitioned into transform units (TUs) according to another quad-tree structure like the coding tree for the CU.

A quad-tree with nested multi-type tree using binary and ternary splits segmentation structure may be used to replace the concepts of multiple partition unit types. In the coding tree structure, a CU can have either a square or rectangular shape. A CTU is first partitioned by a quaternary tree structure. The quaternary tree leaf nodes can be further partitioned by a multi-type tree structure. As shown in a third coding tree structure (404) in FIG. 4C, the multi-type tree structure includes four splitting types. The multi-type tree leaf nodes are called CUs, and unless the CU is too large for the maximum transform length. This means that, the CU, PU, and TU may have the same block size in the quad-tree with a nested multi-type tree coding block structure. An example of block partitions for one CTU (406) is shown in FIG. 4D, which illustrates an example quadtree.

The coding tree scheme supports the ability for the luma and chroma to have a separate block tree structure, such as in VTM7. In some cases, for P and B slices, the luma and chroma CTBs in one CTU share the same coding tree structure. However, for I slices, the luma and chroma can have separate block tree structures. When a separate block tree mode is applied, a luma CTB is partitioned into CUs by one coding tree structure, and the chroma CTBs are partitioned into chroma CUs by another coding tree structure. This means that a CU in an I slice may include, or consist of, a coding block of the luma component or coding blocks of two chroma components, and a CU in a P or B slice may always include, or consist of, coding blocks of all three color components unless the video is monochrome.

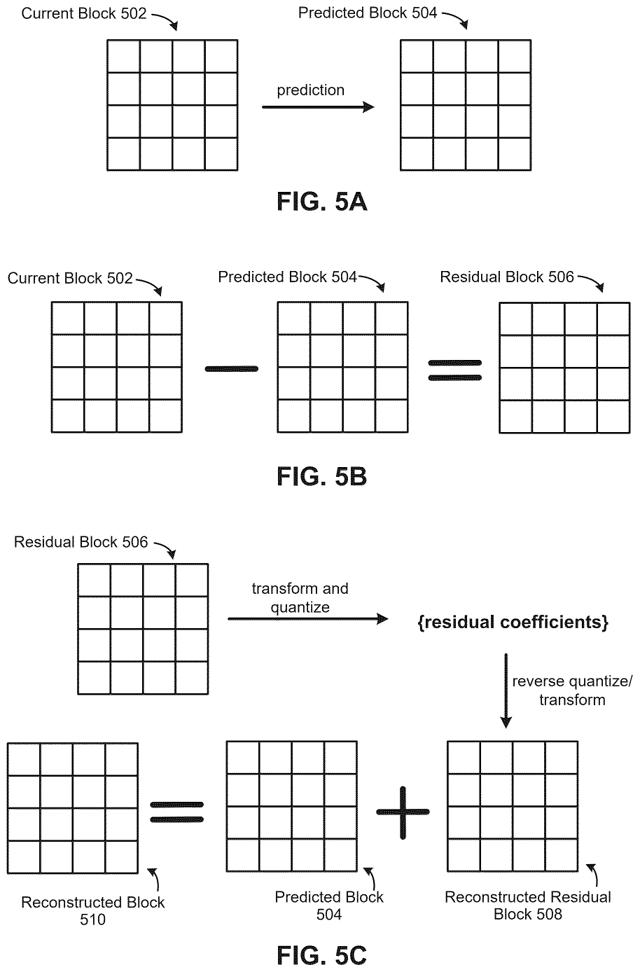

Turning now to example encoding and decoding using prediction and residual blocks, FIG. 5A illustrates the computation of a prediction block in accordance with some embodiments. In the example of FIG. 5A, an intra prediction is performed on a current block 502 to generate a predicted block 504. In some embodiments, an inter prediction is performed to generate the predicted block. The current block 502 includes a set of samples (e.g., pixel blocks) and the prediction block 504 includes a set of predictions that correspond to the set of samples. FIG. 5B illustrates the computation of a residual block in accordance with some embodiments. As shown in FIG. 5B, the prediction block 504 is subtracted from the current block 502 to generate a residual block 506 that includes a set of residues. For example, respective differences are calculated between each sample and the corresponding prediction. FIG. 5C illustrates the computation of a reconstructed block in accordance with some embodiments. As shown in FIG. 5C, the residual block 506 undergoes one or more transformations and quantization to generate a set of residual coefficients. The set of residual coefficients may be transmitted from an encoder component to a decoder component. The set of residual coefficients undergo a reverse quantization and reverse transformation to generate a reconstructed residual block 508. The reconstructed residual block 508 is combined with the predicted block 504 (e.g., reconstructed residues of the reconstructed residual block 508 are added to predictions of the prediction block 504) to generate a reconstructed block 510 corresponding to the current block 502.

Turning now to transforms and transform blocks, in some embodiments, both intra and inter coded blocks can be further partitioned into multiple transform units (e.g., with a partitioning depth up to 2 levels). Multiple transform sizes (e.g., ranging from 4-point to 64-point for each dimension) and transform shapes (e.g., square or rectangular with width/height ratio's 2:1/1:2 and 4:1/1:4) may be utilized. Notably, the transforms performed during decoding of the video bitstream may be inverses of the transformed performed during encoding of the video bitstream, and are sometimes referred to as “inverse transforms”. For simplicity, the transformations described herein are referred to as “transforms” whether performed during encoding or decoding.

A two-dimensional transform process may involve the use of hybrid transform kernels (e.g., composed of different one-dimensional transforms for each dimension of the coded residual block). Primary one-dimensional transforms may include at least one of a) 4-point, 8-point, 16-point, 32-point, 64-point discrete cosine transform DCT-2; b) 4-point, 8-point, 16-point asymmetric discrete sine transforms (DST-4, DST-7) and their flipped versions; or c) 4-point, 8-point, 16-point, 32-point identity transforms.

In some embodiments, separable transforms are applied on residual samples. In some embodiments, a secondary transform scheme is customized for a video coding library (e.g., used for transforming residual blocks). In some situations, the secondary transform scheme can efficiently capture directional patterns in residual samples with lower complexity compared to non-separable primary transforms.

In some embodiments, the secondary transform scheme is enabled for inter coded blocks. For example, secondary transform scheme kernels that are used for intra coded blocks can also be applied to inter coded blocks. In some embodiments, the secondary transform scheme kernels that are used for intra coded blocks are reused for inter coded blocks with no changes or additions. As an example, the encoder can select from multiple sets and multiple kernels within a set (e.g., 7 sets and 3 kernels within a set), and the kernel and set index may be explicitly signaled or derived at the decoder.

According to some embodiments, methods for inter prediction with vector refinement are now described. For example, decoder-side motion vector refinement refines motion vectors using existing decoder-side information, e.g., the reconstructed samples. Bi-directional optical flow (BDOF) refinement can be used to refine the bi-prediction signal of a coding block. As another example, an optical flow equation may be applied to formulate a least squares problem, from which fine motions can be derived from gradients of compound inter prediction samples.

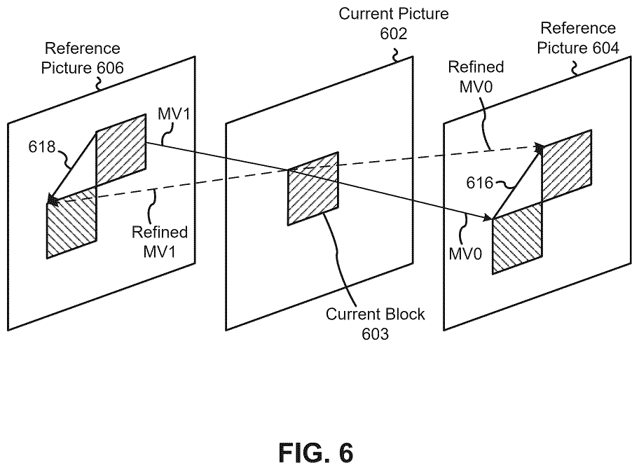

FIG. 6 illustrates an example of decoder-side motion vector refinement in accordance with some embodiments. In FIG. 6, refined motion vectors (Refined MV0 and Refined MV1) are derived using a set of reference picture 604 and 606. An initial reference block may be identified in each reference picture using initial motion vectors, MV0 and MV1. A motion difference (indicated by arrows 616 and 618 in FIG. 6) is applied to each motion vector in FIG. 6 to derive the refined motion vectors. Thus, FIG. 6 illustrates an example of decoder side motion vector refinement (DMVR) being applied to a coding block (e.g., in a merge mode). The pair of MVs obtained from a regular merge candidate may be used as input of the DMVR process. DMVR applies the bilateral matching (BM) to refine the input MV pair {mv_{L0}, mv_{L1}} and uses the refined MV pair for the motion compensated prediction (e.g., of both luma and chroma components). The output MV of DMVR, a refined MV pair, is defined in Equation Set 1:

mv_{refinedL0}=mv_{L0}+Δmv

mv_{refinedL1}=mv_{L1}−Δmv

### Equation Set 1 —Refined Motion Vector Pair

In Equation Set 1, a motion vector difference, Amy, is applied to the input MV pair to obtain the refined MV pair by using an MVD mirroring property (e.g., because the input MV pair point to two different reference pictures that have equal difference in picture order count (POC) to the current picture and these two reference pictures are at different temporal direction).

In an example DMVR process, a luma coded block is divided into 16×16 subblocks for the MV refinement process. The Amy is derived independently for each subblocks in the following two steps, an integer precision motion search followed by a fractional motion search. Finally, the subblock motion compensation (MC) is applied using the refined MV pair {mv_{refinedL0}, mv_{refinedL1}}.

An integer sample offset search may be performed in DMVR. In an example implementation, a search space includes MV pair candidates (e.g., 25 pair candidates) as shown in Equation Set 2:

mv_{L0(i,j)}=mv_{L0(0,0)}+(i,j)

mv_{L1(i,j)}=mv_{L1(0,0)}−(i,j)

### Equation Set 2—Search Space for MV Pair Candidates

where (i, j) represents the coordinate of the search point around the initial MV pair, and i and j are integer value between −2 and 2 inclusive. The sum of absolute difference (SAD) for the initial MV pair is calculated as shown in Equation Set 3 below:

$$SAD ( i , j ) = K {\sum }_{n = 0}^{\frac{H}{2}} {\sum }_{m = 0}^{W} {diff}_{m , n} \qquad Equation Set 3 - SAD Calculation$$

$${diff}_{m , n} = abs ( P {0}_{i , j} [ m + i , 2 n + j ] - P {1}_{i , j} [ m - i , 2 n - j ] )$$

$$K = \{ \begin{matrix}3 / 4 i = 0 , j = 0 \\ 1 otherwise\end{matrix}$$

where W and H are the weight and height of the subblock. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. In some embodiments, e.g., to reduce the penalty of the uncertainty of DMVR refinement, the SAD between the reference blocks referred by the initial MV candidates is decreased by ¼ of the SAD value.

In some embodiments, the candidate MV pair selected in the integer sample offset search step is further refined. For example, the fractional sample refinement may be derived by using parametric error surface equation (e.g., to save the calculational complexity), instead of additional search with SAD comparison. The fractional sample refinement is conditionally invoked based on the output of the integer sample search stage. For example, the fractional sample refinement is conditionally invoked based on the output of the integer sample search stage. As an example, when the integer sample search stage is terminated with center having the smallest SAD in either the first iteration or the second iteration search, the fractional sample refinement is further applied.

An optical flow refinement (e.g., BDOF) may be used to refine the bi-prediction signal of a coding block (e.g., a CU). For example, BDOF may be performed at a 4×4 subblock level. In some embodiments, BDOF may be applied to a coding block if it satisfies at least a subset of the following conditions: (i) the coding block is coded using a bi-prediction mode in which one of the two reference pictures is prior to the current picture in display order and the other is after the current picture in display order, (ii) the distances (e.g., the POC difference) from two reference pictures to the current picture are same, (iii) both of the reference pictures are short-term reference pictures, (iv) the coding block is not coded using an affine mode or an SbTVMP merge mode, (v) coding unit has more than 64 luma samples, (vi) the coding unit height and width are larger than or equal to 8 luma samples, (vii) BCW weight index indicates equal weight, (viii) WP is not enabled for the current coding block, and (ix) CIIP mode is not used for the current coding block. In some implementations, BDOF is only applied to a luma component.

The BDOF mode is based on an optical flow concept, which assumes that the motion of an object is smooth. For each block (e.g., 4×4 subblock), a motion refinement (vₓ, v_{y}) may be calculated by minimizing the difference between the L0 and L1 prediction samples. The motion refinement can then be used to adjust the bi-predicted sample values in the block, as discussed in detail below.

The horizontal and vertical gradients,

$$\frac{\partial {I}^{( k )}}{\partial x} ( i , j ) and \frac{\partial {I}^{( k )}}{\partial y} ( i , j ) , k = 0 , 1 ,$$

of the two prediction signals can be computed by directly calculating the difference between two neighboring samples as shown below in Equation Set 4:

$$Equation Set 4 - Gradient Calculations$$

$$\frac{\partial {I}^{( k )}}{\partial x} ( i , j ) = ( ( {I}^{( k )} ( i + 1 , j ) >> shift 1 ) - ( {I}^{( k )} ( i - 1 , j ) >> shift 1 ) )$$

$$\frac{\partial {I}^{( k )}}{\partial y} ( i , j ) = ( ( {I}^{( k )} ( i , j + 1 ) >> shift 1 ) - ( {I}^{( k )} ( i , j - 1 ) >> shift 1 ) )$$

where I^{(k)}(i,j) are the sample value at coordinate (i,j) of the prediction signal in list k, k=0,1, and shift1 is calculated based on the luma bit depth, bitDepth, as shift1=max (6, bitDepth-6). Then, the auto- and cross-correlation of the gradients, S₁, S₂, S₃, S₅ and S₆, are calculated as shown in Equation Set 5:

$$Equation Set 5 - Auto - and Cross - correlation Calculations$$

$${S}_{1} = {\sum }_{( i , j ) ∈ Ω} Abs ( {ψ}_{x} ( i , j ) ) , {S}_{3} = {\sum }_{( i , j ) ∈ Ω} θ ( i , j ) \cdot Sign ( {ψ}_{x} ( i , j ) )$$

$${S}_{2} = {\sum }_{( i , j ) ∈ Ω} {ψ}_{x} ( i , j ) \cdot Sign ( {ψ}_{y} ( i , j ) )$$

$${S}_{5} = {\sum }_{( i , j ) ∈ Ω} Abs ( {ψ}_{y} ( i , j ) ) , {S}_{6} = {\sum }_{( i , j ) ∈ Ω} θ ( i , j ) \cdot Sign ( {ψ}_{y} ( i , j ) )$$

where ψ and θ are defined by Equation Set 6:

$${ψ}_{x} ( i , j ) = ( \frac{\partial {I}^{( 1 )}}{\partial x} ( i , j ) + \frac{\partial {I}^{( 0 )}}{\partial x} ( i , j ) ) >> {n}_{a} \qquad Equation Set 6$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) >> {n}_{a}$$

$$θ ( i , j ) = ( {I}^{( 1 )} ( i , j ) >> {n}_{b} ) - ( {I}^{( 0 )} ( i , j ) >> {n}_{b} )$$

where Ω is a 6×6 window around the subblock, and the values of nₐ and n_{b} are set equal to min(1, bitDepth−11) and min(4, bitDepth−8), respectively.

The motion refinement (vₓ, v_{y}) can then be derived using the cross- and auto-correlation terms using Equation Set 7:

$$Equation Set 7 - Motion Refinement Calculation$$

$${v}_{x} = {S}_{1} > 0 ? clip 3 ( - {th}_{BIO}^{′} , {th}_{BIO}^{′} , - ( ( {S}_{3} \cdot {2}^{{n}_{b} - {n}_{a}} ) >> ⌊ {log}_{2} {S}_{1} ⌋ ) ) : 0$$

$${v}_{y} = {S}_{5} > 0 ? clip 3 ( - {th}_{BIO}^{′} , {th}_{BIO}^{′} , - ( ( {S}_{6} \cdot {2}^{{n}_{b} - {n}_{a}} - ( ( {v}_{x} {S}_{2 , m} ) << {n}_{{S}_{2}} + {v}_{x} {S}_{2 , s} ) / 2 ) >> ⌊ {log}_{2} {S}_{5} ⌋ ) ) : 0$$

where

$${S}_{2 , m} = {S}_{2} >> {n}_{{S}_{2}} , {S}_{2 , s} = {S}_{2} \& ( {2}^{{n}_{{S}_{2}}} - 1 ) , {th}_{BIO}^{′} = {2}^{max ( 5 , BD - 7 )} . ⌊ \cdot ⌋$$

is the floor function, and nₛ_{₂}=12.

Based on the motion refinement and the gradients, an adjustment can be calculated for each sample in the subblock using Equation Set 8:

$$Equation Set 8 - Motion Refinement Adjustment Calculation$$

$$b ( x , y ) = rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 )$$

The BDOF samples of the coding block can then be calculated by adjusting the bi-prediction samples as follows:

pred_{BDOF}(x,y)=(I⁽⁰⁾(x,y)+I⁽¹⁾(x,y)+b(x,y)+o_{offset})>>shift

### Equation 9—BDOF Calculation

These values may be selected such that the multipliers in the BDOF process do not exceed 15-bit, and the maximum bit-width of the intermediate parameters in the BDOF process is kept within 32-bit.

To derive the gradient values, some prediction samples I^{(k)}(i, j) in list k (k=0,1) outside of the current coding block boundaries may be identified and used. For example, BDOF may use one extended row/column around the coding block boundaries. For example, prediction samples in the extended area may be generated by taking the reference samples at the nearby integer positions (e.g., using a floor( ) operation on the coordinates) directly without interpolation (e.g., to control the computational complexity of generating the out-of-boundary prediction samples), and the normal 8-tap motion compensation interpolation filter is used to generate prediction samples within the coding block. These extended sample values may be used in the gradient calculation. For the other steps in the BDOF process, if any sample and gradient values outside of the coding block boundaries are needed, they may be padded (e.g., copied) from their nearest neighbors.

In some implementations, a multi-pass decoder-side motion vector refinement is applied. For example, in the first pass, bilateral matching (BM) is applied to the coding block, in the second pass, BM is applied to each 16×16 subblock within the coding block, and, in the third pass, the MV in each 8×8 subblock is refined by applying bi-directional optical flow (BDOF). The refined MVs may then be stored for subsequent spatial and/or temporal motion vector predictions.

As discussed above, decoder-side motion vector refinement refines motion vectors using the existing decoder-side information, e.g., the reconstructed samples. Additionally, an optical flow equation may be applied to formulate a least squares problem, from which fine motions can be derived from gradients of compound inter prediction samples. With those fine motions, the MV may be refined per subblock within a prediction block, thereby enhancing inter prediction quality. This implementation is an extension of BDOF as it supports MV refinement when the two reference blocks have arbitrary temporal distances to the current block. The gradient of the current whole block predictors may be pre-computed and the subblock refined MVs may then be computed depending on the optical flow model.

Bilateral matching may be used for the MV refinement. In bilateral matching-based decoder side motion vector refinement, two candidate predictor blocks may be directly compared using distortion metrics such as the sum of absolute difference (SAD). The candidate blocks with lowest distortion may then be used as the refined block. Decoder side motion vector refinement can be performed at block level or subblock level. In the subblock level, the current block is divided into multiple subblocks, and each subblock bilateral matching is performed independently. The subblock based decoder-side motion vector refinement can achieve motion vector refinement at finer granularity, e.g., the subblock level, but the matching cost may be also less accurate as less samples are used to conclude the matching cost.

Turning now to entropy coding. Entropy coding in video codecs uses context-based (e.g., conditional) probabilities so that the symbols can be coded with one or more probability models that can best capture the statistics governed by a condition or higher order conditions.

The term “probability model” (sometimes referred to as a “symbol probability model”) refers to any aspect about deriving the probability of a symbol during entropy coding, which is used to determine the output of a context-based arithmetic coding engine. Examples of design aspects of probability model can include the context initialization probability/state, probability update window size/speed, context derivation process, number of contexts, number of windows, or codewords.

Entropy coding in modern video codecs use context-based (e.g., conditional) probabilities so that the symbols can be arithmetic coded with probability models that best capture the statistics governed by the current state of the codec. Design aspects of the context-based probability models include, but are not limited to, initial context probabilities, e.g., defined as Cumulative Density Functions (CDFs), CDF update window size and speed, context derivation process and the number of contexts, windows, codewords, and the like. Additionally, the group of CDFs associated with an entire frame or tile may be referred to as frame and tile contexts, respectively.

Coefficients and other coding parameters are signaled in a video bitstream. The signaling may involve bypass coding, arithmetic coding, and/or other types of coding (e.g., to reduce signaling overhead). Some systems use a tree-based Boolean non-adaptive binary arithmetic encoder to encode syntax elements for a video bitstream.

The entropy coding in modern codecs have been widely using the context-based (e.g., conditional) probabilities so that the symbols can be coded with probability model that can best capture the statistics governed by a condition or higher order conditions. Some systems employ an adaptive multi-symbol (M-ary) arithmetic coder (e.g., a symbol-to-symbol adaptive encoder). For example, each syntax element may be a member of a specific alphabet of N elements, and a corresponding context consists of a set of N probabilities together with a count, e.g., to facilitate fast early adaptation. The higher precision (as compared to a binary arithmetic encoder) allows for accurate tracking probabilities of less common elements of an alphabet. Probabilities may be adapted by simple recursive scaling, with an update factor based on the alphabet size.

Some systems use M-ary symbol arithmetic coding techniques to compress the syntax elements. In some embodiments, the probability model for arithmetic coding is updated per coded symbol. A cumulative distribution function (CDF) may be used to represent the probability that a random variable may take a value that is less than or equal to a particular threshold value. For example, some codecs store M-ary symbol probabilities in the form of CDFs. Arithmetic coding may directly use the CDFs to compress symbols. As described previously, the initialization of a probability model can occur at various places during encoding and decoding.

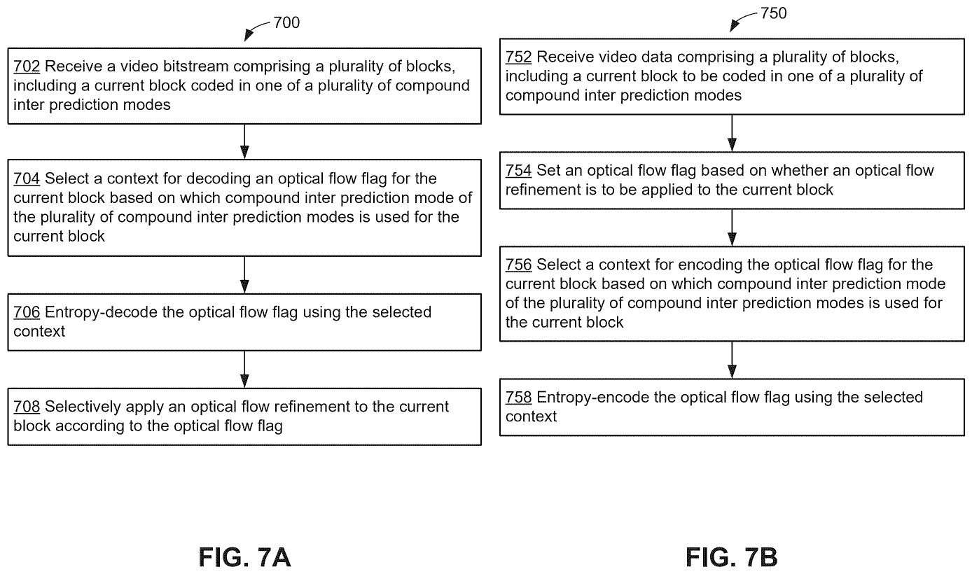

FIG. 7A is a flow diagram illustrating a method 700 of decoding video in accordance with some embodiments. The method 700 may be performed at a computing system (e.g., the server system 112, the source device 102, or the electronic device 120) having control circuitry and memory storing instructions for execution by the control circuitry. In some embodiments, the method 700 is performed by executing instructions stored in the memory (e.g., the memory 314) of the computing system.

The system receives (702) a video bitstream (e.g., a coded video sequence) comprising a plurality of blocks (e.g., encoded blocks), including a current block coded in one of a plurality of compound inter prediction modes. The system selects (704) a context for decoding an optical flow flag for the current block based on which compound inter prediction mode of the plurality of compound inter prediction modes is used for the current block. The system entropy-decodes (706) the optical flow flag using the selected context. The system selectively applies (708) an optical flow refinement to the current block according to the optical flow flag. In this way, the context for signaling optical flow mode flag depends on the inter compound mode of the current inter coding block.

In some embodiments, the signaling of optical flow flag of current coding block depends on the inter compound prediction mode flag of the current coding block, and/or the reference frames of current coding block, and/or the inter prediction modes (and/or the reference frames) of neighboring coding blocks.

In some embodiments, the context for signaling optical flow mode flag depends on the POC distance between two reference frames and the current frame. For example, if the POC distance between two reference frames and current frame is different, one set of contexts is used. Otherwise, another set of contexts are used instead.

In some embodiments, the MVD is further signaled when one of NEWMV, NEAREST_NEWMV, NEW_NEARESTMV, NEAR_NEWMV, NEW_NEARMV, or NEW_NEWMV is applied. In some embodiments, when the mode is equal to NEW_NEARESTMV, NEW_NEARMV, or NEW_NEWMV, the MVD is signalled for the MV that is associated with the first reference frame. In some embodiments, when the mode is equal to NEAREST_NEWMV, NEAR_NEWMV, or NEW_NEWMV, the MVD is signalled for the MV that is associated with the second reference frame.

As an example, if the current compound inter prediction mode is NEAR_NEARMV, one set of contexts is used. Otherwise, if the current compound inter prediction mode is NEAR_NEWMV, one set of contexts is used. Otherwise, if the current compound inter prediction mode is NEW_NEARMV, one set of contexts is used. Otherwise, if the current compound inter prediction mode is NEW_NEWMV, one set of contexts is used. Otherwise, another set of contexts are used instead. As another example, if the current compound inter prediction mode is NEAR_NEARMV, one set of contexts is used. Otherwise, another set of contexts are used instead. In another example, if the current compound inter prediction mode is JOINT_NEWMV or JOINT_AMVDNEWMV, one set of contexts is used. Otherwise, another set of contexts are used instead. In another example, if the current compound inter prediction mode is NEAR_NEARMV or NEAR_NEWMV, one set of contexts is used. Otherwise, another set of contexts are used instead. In another example, if the current compound inter prediction mode is NEAR_NEARMV or NEW_NEARMV, one set of contexts is used. Otherwise, another set of contexts are used instead.

In some embodiments, the context for signaling optical flow mode flag depends on the optical flow mode of the neighboring coded blocks. For example, if the optical flow mode is used in the left neighboring block and/or the above neighboring block, one set of contexts is used. Otherwise, another set of contexts are used instead.

In some embodiments, the flag for whether to apply the secondary transform kernel is signaled, then if the secondary transform is applied to the current block, the secondary transform kernel (type) index and the secondary transform set index are signaled.

In some embodiments, the context for signaling whether to apply the secondary transform kernel depends on (i) whether (or how many of) the neighboring transform blocks use the secondary transform kernel, (ii) whether the current transform block is within an intra coded block, and/or (iii) the on the current transform block size.

In some embodiments, when secondary transform is allowed to be used for current block, at least one flag is signaled to indicate whether the secondary transform is applied to the current transform block or not.

In some embodiments, the context for signaling secondary transform flag depends only on whether the current transform block is within an intra coded block or not. For example, two contexts are used to signal the secondary transform flag. If the current transform block is within an intra coded block, one context is used to signal whether the secondary transform is applied to the current block. If the current transform block is within an inter coded block, another one context is used to signal whether the secondary transform is applied to the current block.

In some embodiments, the context for signaling secondary transform flag depends on whether the neighboring transform blocks use the secondary transform kernel. For example, if the secondary transform is applied to the left neighboring block and/or the above neighboring block, one set of contexts is used. Otherwise, another set of contexts are used instead.

In some embodiments, when secondary transform is allowed for one (transform) block, the first flag is signaled to indicate whether secondary transform is applied or not. If secondary transform is applied, the second flag is signaled to indicate which secondary transform kernel or index is applied.

In some embodiments, the signaling of the first flag depends on whether current coded block is intra coded block or inter coded block.

In some embodiments, the signaling of the second flag depends on the block size (or block size group) of current block, wherein intra coded block and inter coded blocks share the same context when the block size (or block size group) is the same.

In some embodiments, when the secondary transform is used and the secondary transform flag is signaled, the secondary transform kernel index (type) is signaled to indicate which one of the secondary transform kernel is used. The context for signaling the secondary transform kernel (type) depends only on the size of the current transform block. For example, three contexts are used to signal the secondary transform index. If the width and/or height of the current transform block is smaller than or equal to M, one context is used to signal the secondary transform kernel index. Otherwise, if the width and/or height of the current transform block is smaller than or equal to N, another one context is used to signal the secondary transform kernel index. Otherwise, another one context is used to signal the secondary transform kernel index. In one example, N is equal to 8, 16, or 32. In one example, M is set to 4.

As another example, four contexts are used to signal the secondary transform index. If the width and/or height of the current transform block is smaller than or equal to M, one context is used to signal the secondary transform kernel index. Otherwise, if the width and/or height of the current transform block is smaller than or equal to N, another one context is used to signal the secondary transform kernel index. Otherwise, if the width and/or height of the current transform block is smaller than or equal to P, another one context is used to signal the secondary transform kernel index. Otherwise, another one context is used to signal the secondary transform kernel index. In one example, M is set to 4, and N is set to 8, and P is set to 16.

In some embodiments, when the secondary transform is used and the secondary transform flag is signaled, the secondary transform kernel index (type) is signaled to indicate which one of the secondary transform kernels is used. The context for signaling the secondary transform kernel (type) depends on the transform unit depth.

FIG. 7B is a flow diagram illustrating a method 750 of encoding video in accordance with some embodiments. The method 750 may be performed at a computing system (e.g., the server system 112, the source device 102, or the electronic device 120) having control circuitry and memory storing instructions for execution by the control circuitry. In some embodiments, the method 750 is performed by executing instructions stored in the memory (e.g., the memory 314) of the computing system. In some embodiments, the method 750 is performed by a same system as the method 700 described above.

The system receives (752) video data (e.g., a source video sequence) comprising a plurality of blocks (e.g., corresponding to one or more frames), including a current block to be coded in one of a plurality of compound inter prediction modes. The system sets (754) an optical flow flag based on whether an optical flow refinement is to be applied to the current block. The system selects (756) a context for encoding the optical flow flag for the current block based on which compound inter prediction mode of the plurality of compound inter prediction modes is used for the current block. The system entropy-encodes (758) the optical flow flag using the selected context. In some embodiments, the system signals the entropy-encoded optical flow flag in a video bitstream. In some embodiments, the system signals the encoded current block in the video bitstream. As described previously, the encoding process may mirror the decoding processes described herein (e.g., entropy coding and transforms). For brevity, those details are not repeated here.

Although FIGS. 7A and 7B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

It is desirable to reduce the amount of storage needed for entropy coding. In embodiments described herein, the context models for coding the optical flow refinement flag may be reduced from 5 context models to 2 context models, e.g., by using the inter compound mode of the current block to derive contexts.

In some embodiments, the compound inter mode of the current block is used to derive the context. Specifically, two context models may be used. For example, if the compound inter mode of the current block uses NEAR_NEARMV, one context is used to signal the use OPFL mode flag. If the compound inter mode of the current block uses other modes (e.g., NEW_NEWMV, NEAR_NEWMV, NEW_NEARMV, JOINT_NEWMV, JOINT_AMVDNEWMV, etc.), another context is used to signal the use OPFL mode flag. In this way, no other operations like mask, shift or mapping are required.

Table 1 below illustrates the improvements to signal-to-noise ratio based on simulations performed using current designs (e.g., AVM research-v9) with various video data (e.g., representing AOM Test Conditions). Table 2 below illustrates improvements to memory usage compared to current designs (e.g., AVM research-v9).

TABLE 1
Simulation Results

| | Y-PSNR | U-PSNR | V-PSNR | YUV-PSNR |
|---|---|---|---|---|
| Random Access | −0.04% | −0.01% | 0.03% | −0.03% |

TABLE 2
Memory Usage

| | | Inter | |
|---|---|---|---|
| | | compound | |
| | Conventional | mode-based | |
| | approach | Context | Difference |
| Memory for CDF storage: | 5*(15*(2 − | 2*(15*(2 − | 60 |
| Total_ctxs*((Nsym − 1)*15 | 1) + 5) = 100 | 1) + 5) = 40 | |
| bits) + 5 bit counter) | | | |

(A1) In one aspect, some embodiments include a method (e.g., the method 700) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream comprising a plurality of blocks (e.g., corresponding to a set of pictures), including a current block coded in one of a plurality of compound inter prediction modes; (ii) selecting a context for decoding an optical flow flag for the current block based on which compound inter prediction mode of the plurality of compound inter prediction modes is used for the current block; (iii) entropy-decoding the optical flow flag using the selected context; and (iv) selectively applying an optical flow refinement to the current block according to the optical flow flag. In this way, the context for signaling optical flow mode flag depends on the inter compound mode of the current inter coding block. In some embodiments, the method further comprises reconstructing the current block after applying the optical flow refinement. In some embodiments, the plurality of compound inter prediction modes includes one or more of a NEAR_NEARMV mode, a NEAR_NEWMV mode, a NEW_NEWMV mode, a JOINT_NEWMV mode, a JOINT_AMVDNEWMV mode, a NEW_NEARMV mode, and a GLOBAL_GLOBALMV mode. In some embodiments, the context is selected and the optical flow flag is entropy-decoded without performing any shifting, masking, or mapping operations.

(A2) In some embodiments of A1, the context for decoding the optical flow flag for the current block is selected based on whether a compound inter prediction mode for the current block utilizes one or more motion vector differences. For example, a first context may be selected for modes that do not use MVDs (e.g., NEAR_NEARMV), and one or more different contexts are selected for other modes.

(A3) In some embodiments of A1, the context for decoding the optical flow flag for the current block is selected based on how many motion vector differences are used for a compound inter prediction mode for the current block.

(A4) In some embodiments of any of A1-A3, selecting the context for decoding the optical flow flag for the current block comprises: (i) when a compound inter prediction mode for the current block is NEAR_NEARMV, the context is selected from a first set of one or more contexts; and (ii) when the compound inter prediction mode for the current block is not NEAR_NEARMV, the context is selected from a second set of one or more contexts. For example, if the current compound inter prediction mode is NEAR_NEARMV, one set of contexts is used. Otherwise, another set of contexts are used instead. In some embodiments, the context(s) of the first set of contexts are different than the context(s) of the second set of contexts. In some embodiments, in accordance with a determination that the compound inter prediction mode is NEAR_NEARMV a first context is selected, and, in accordance with a determination that the compound inter prediction mode is not NEAR_NEARMV, a second context is selected, the second context being different than the first context. As another example, if the current compound inter prediction mode is NEAR_NEARMV or NEAR_NEWMV, one set of contexts is used. Otherwise, another set of contexts are used instead. As another example, if the current compound inter prediction mode is NEAR_NEARMV or NEW_NEARMV, one set of contexts is used. Otherwise, another set of contexts are used instead.

(A5) In some embodiments of any of A1-A3, selecting the context for decoding the optical flow flag for the current block comprises: (i) when a compound inter prediction mode for the current block is NEAR_NEARMV, a first context is selected; (ii) when the compound inter prediction mode for the current block is NEAR_NEWMV, a second context is selected; and (iii) when the compound inter prediction mode for the current block is not NEAR_NEARMV or NEAR_NEWMV, a third context is selected. For example, if the current compound inter prediction mode is NEAR_NEARMV, one set of contexts is used. If the current compound inter prediction mode is NEAR_NEWMV, another set of contexts is used. If the current compound inter prediction mode is NEW_NEARMV, another set of contexts is used. If the current compound inter prediction mode is NEW_NEWMV, another set of contexts is used. Otherwise, yet another set of contexts is used. In some embodiments, different contexts are used for NEAR_NEARMV, NEAR_NEWMV, NEW_NEARMV, and NEW_NEWMV.

(A6) In some embodiments of any of A1-A3, selecting the context for decoding the optical flow flag for the current block comprises: (i) when a compound inter prediction mode for the current block is JOINT_NEWMV or JOINT_AMVDNEWMV, a first context is selected; and (ii) when the compound inter prediction mode for the current block is not JOINT_NEWMV or JOINT_AMVDNEWMV, a second context is selected. For example, if the current compound inter prediction mode is JOINT_NEWMV or JOINT_AMVDNEWMV, one set of contexts is used. Otherwise, another set of contexts are used instead.

(A7) In some embodiments of any of A1-A6, signaling of the optical flow flag is based on one or more of: (i) which compound inter prediction mode of the plurality of compound inter prediction modes is used for the current block, (ii) one or more properties of a reference frame for the current block, (iii) one or more inter prediction modes of neighboring blocks of the current block, and (iv) one or more reference frames of neighboring blocks of the current block. For example, the signaling of an optical flow flag of a current coding block may depend on the inter compound prediction mode flag of the current coding block, and/or the reference frames of current coding block, and/or the inter prediction modes (and/or the reference frames) of neighboring coding blocks.

(A8) In some embodiments of any of A1-A7, the context is further based on a picture order count (POC) distance between a current frame for the current block and one or more reference frames. For example, the context for signaling optical flow mode flag may depend on the POC distance between two reference frames and the current frame. In some embodiments, the context is based on the POC distance, but not the compound inter prediction mode.

(A9) In some embodiments of A8: (i) a compound inter prediction mode for the current block uses two reference frames; (ii) when the two reference frames have a same POC distance to the current frame, a first context is selected for decoding the optical flow flag; and (iii) when the two reference frames have different POC distances to the current frame, a second context is selected for decoding the optical flow flag. For example, if the POC distance between two reference frames and current frame is different, one set of contexts is used. Otherwise, another set of contexts are used instead.

(A10) In some embodiments of any of A1-A9, the context is further based on whether an optical flow refinement mode is enabled for one or more neighboring blocks for the current block. For example, the context for signaling optical flow mode flag depends on the optical flow mode of the neighboring coded blocks. In some embodiments, the context is based on the neighboring optical flow refinement modes, but not the compound inter prediction mode. As an example, if the optical flow mode is used in the left neighboring block and/or the above neighboring block, one set of contexts is used. Otherwise, another set of contexts are used instead.

(A11) In some embodiments of any of A1-A10, the method further comprises, when a secondary transform is applied for the current block: (i) selecting a second context for decoding a secondary transform kernel indicator for a current transform block of the current block based on a size of the current transform block; and (ii) entropy-decoding the secondary transform kernel indicator using the selected second context. For example, when the secondary transform is used and the secondary transform flag is signaled, the secondary transform kernel index (type) may be signaled to indicate which one of the secondary transform kernel is used. The context for signaling the secondary transform kernel (type) may depend only on the size of the current transform block.

(B1) In another aspect, some embodiments include a method (e.g., the method 750) of video encoding. In some embodiments, the method is performed at a computing system having memory and one or more processors. The method includes: (i) receiving video data (e.g., a source video sequence) comprising a plurality of blocks, including a current block to be coded in one of a plurality of compound inter prediction modes; (ii) setting an optical flow flag based on whether an optical flow refinement is to be applied to the current block; (iii) selecting a context for encoding the optical flow flag for the current block based on which compound inter prediction mode of the plurality of compound inter prediction modes is used for the current block; and (iv) entropy-encoding the optical flow flag using the selected context. In some embodiments, the method further comprises signaling the entropy-encoded optical flow flag in a video bitstream. In some embodiments, the method further comprises signaling the encoded current block in the video bitstream.

(B2) In some embodiments of B1, the context for encoding the optical flow flag for the current block is selected based on whether a compound inter prediction mode for the current block utilizes one or more motion vector differences.

(B3) In some embodiments of B1, the context for encoding the optical flow flag for the current block is selected based on how many motion vector differences are used for a compound inter prediction mode for the current block.

(B4) In some embodiments of any of B1-B3, selecting the context for decoding the optical flow flag for the current block comprises: (i) when a compound inter prediction mode for the current block is NEAR_NEARMV, the context is selected from a first set of one or more contexts; and (ii) when the compound inter prediction mode for the current block is not NEAR_NEARMV, the context is selected from a second set of one or more contexts.

(B5) In some embodiments of any of B1-B4, signaling of the optical flow flag is based on one or more of: (i) which compound inter prediction mode of the plurality of compound inter prediction modes is used for the current block, (ii) one or more properties of a reference frame for the current block, (iii) one or more inter prediction modes of neighboring blocks of the current block, and (iv) one or more reference frames of neighboring blocks of the current block.

(B6) In some embodiments of any of B1-B5, the method further includes encoding-side analogues of any of the features described above with respect to A1-A11.

(C1) In one aspect, some embodiments include a method of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream comprising a plurality of blocks, including a current block and a corresponding current transform block; (ii) selecting a context for decoding a secondary transform kernel for the current transform block, wherein the context is based on a size of the current transform block; and (iii) entropy-decoding the secondary transform kernel using the selected context. In some embodiments, the method further comprises applying the secondary transform using the secondary transform kernel. In some embodiments, the method further comprises reconstructing the current block after performing the secondary transform. As an example, when the secondary transform is used and the secondary transform flag is signaled, the secondary transform kernel index (type) is signaled to indicate which one of the secondary transform kernel is used. The context for signaling the secondary transform kernel (type) depends only on the size of the current transform block.

(C2) In some embodiments of C1, the method further comprises obtaining, from the video bitstream, a secondary transform flag indicating that a secondary transform is applied for the current transform block. In some embodiments, the context is selected in accordance with the secondary transform flag indicating the secondary transform is to be applied.

(C3) In some embodiments of C1 or C2, the context is selected from a set of three contexts. For example, three contexts are used to signal the secondary transform index. If the width and/or height of the current transform block is smaller than or equal to M, one context is used to signal the secondary transform kernel index. Otherwise, if the width and/or height of the current transform block is smaller than or equal to N, another one context is used to signal the secondary transform kernel index. Otherwise, another one context is used to signal the secondary transform kernel index. As an example, N may be equal to 8, 16, or 32. In one example, M is equal to 4.

(C4) In some embodiments of C1 or C2, the context is selected from a set of four contexts. For example, four contexts are used to signal the secondary transform index. If the width and/or height of the current transform block is smaller than or equal to M, one context is used to signal the secondary transform kernel index. Otherwise, if the width and/or height of the current transform block is smaller than or equal to N, another one context is used to signal the secondary transform kernel index. Otherwise, if the width and/or height of the current transform block is smaller than or equal to P, another one context is used to signal the secondary transform kernel index. Otherwise, another one context is used to signal the secondary transform kernel index. In one example, M is set to 4, N is set to 8, and P is set to 16.

(C5) In some embodiments of any of C1-C4, the context for decoding the secondary transform kernel is further based on a transform unit depth. In some embodiments, the context is based on the transform unit depth, but not the size of the current transform block. As an example, when the secondary transform is used and the secondary transform flag is signaled, the secondary transform kernel index (type) is signaled to indicate which one of the secondary transform kernels is used. The context for signaling the secondary transform kernel (type) depends on the transform unit depth.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., the methods 700, 750, as well as A1-A11, B1-B6, and C1-C5 above). In another aspect, some embodiments include a non-transitory computer-readable storage medium storing one or more sets of instructions for execution by control circuitry of a computing system, the set(s) of instructions including instructions for performing any of the methods described herein (e.g., the methods 700, 750, as well as A1-A11, B1-B6, and C1-C5 above). In some embodiments, a memory or non-transitory computer-readable storage medium stores a video bitstream including any of the features (e.g., syntax and encoded information) disclosed herein.

Unless otherwise specified, any of the syntax elements described herein may be HLS. As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “when” can be construed to mean “if” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks, including a current block coded in one of a plurality of compound inter prediction modes;
selecting a context for decoding an optical flow flag for the current block based on which compound inter prediction mode of the plurality of compound inter prediction modes is used for the current block;
entropy-decoding the optical flow flag using the selected context; and
selectively applying an optical flow refinement to the current block according to the optical flow flag.

2. The method of claim 1, wherein the context for decoding the optical flow flag for the current block is selected based on whether a compound inter prediction mode for the current block utilizes one or more motion vector differences.

3. The method of claim 1, wherein the context for decoding the optical flow flag for the current block is selected based on how many motion vector differences are used for a compound inter prediction mode for the current block.

4. The method of claim 1, wherein selecting the context for decoding the optical flow flag for the current block comprises:
when a compound inter prediction mode for the current block is NEAR_NEARMV, the context is selected from a first set of one or more contexts; and
when the compound inter prediction mode for the current block is not NEAR_NEARMV, the context is selected from a second set of one or more contexts.

5. The method of claim 1, wherein selecting the context for decoding the optical flow flag for the current block comprises:
when a compound inter prediction mode for the current block is NEAR_NEARMV, a first context is selected;
when the compound inter prediction mode for the current block is NEAR_NEWMV, a second context is selected; and
when the compound inter prediction mode for the current block is not NEAR_NEARMV or NEAR_NEWMV, a third context is selected.

6. The method of claim 1, wherein selecting the context for decoding the optical flow flag for the current block comprises:
when a compound inter prediction mode for the current block is JOINT_NEWMV or JOINT_AMVDNEWMV, a first context is selected; and
when the compound inter prediction mode for the current block is not JOINT_NEWMV or JOINT_AMVDNEWMV, a second context is selected.

7. The method of claim 1, wherein signaling of the optical flow flag is based on one or more of: (i) which compound inter prediction mode of the plurality of compound inter prediction modes is used for the current block, (ii) one or more properties of a reference frame for the current block, (iii) one or more inter prediction modes of neighboring blocks of the current block, and (iv) one or more reference frames of neighboring blocks of the current block.

8. The method of claim 1, wherein the context is further based on a picture order count (POC) distance between a current frame for the current block and one or more reference frames.

9. The method of claim 8, wherein:
a compound inter prediction mode for the current block uses two reference frames;
when the two reference frames have a same POC distance to the current frame, a first context is selected for decoding the optical flow flag; and
when the two reference frames have different POC distances to the current frame, a second context is selected for decoding the optical flow flag.

10. The method of claim 1, wherein the context is further based on whether an optical flow refinement mode is enabled for one or more neighboring blocks for the current block.

11. The method of claim 1, further comprising, when a secondary transform is applied for the current block:
selecting a second context for decoding a secondary transform kernel indicator for a current transform block of the current block based on a size of the current transform block; and
entropy-decoding the secondary transform kernel indicator using the selected second context.

12. A method of video encoding performed at a computing system having memory and one or more processors, the method comprising:
receiving video data comprising a plurality of blocks, including a current block to be coded in one of a plurality of compound inter prediction modes;
setting an optical flow flag based on whether an optical flow refinement is to be applied to the current block;
selecting a context for encoding the optical flow flag for the current block based on which compound inter prediction mode of the plurality of compound inter prediction modes is used for the current block; and
entropy-encoding the optical flow flag using the selected context.

13. The method of claim 12, wherein the context for encoding the optical flow flag for the current block is selected based on whether a compound inter prediction mode for the current block utilizes one or more motion vector differences.

14. The method of claim 12, wherein the context for encoding the optical flow flag for the current block is selected based on how many motion vector differences are used for a compound inter prediction mode for the current block.

15. The method of claim 12, wherein selecting the context for decoding the optical flow flag for the current block comprises:
when a compound inter prediction mode for the current block is NEAR_NEARMV, the context is selected from a first set of one or more contexts; and
when the compound inter prediction mode for the current block is not NEAR_NEARMV, the context is selected from a second set of one or more contexts.

16. The method of claim 12, wherein signaling of the optical flow flag is based on one or more of: (i) which compound inter prediction mode of the plurality of compound inter prediction modes is used for the current block, (ii) one or more properties of a reference frame for the current block, (iii) one or more inter prediction modes of neighboring blocks of the current block, and (iv) one or more reference frames of neighboring blocks of the current block.

17. A non-transitory computer-readable storage medium storing a video bitstream that is generated by a video encoding method, the video bitstream comprising:
a plurality of encoded blocks, including a current block encoded in one of a plurality of compound inter prediction modes; and
an entropy-encoded optical flow flag for a current block of video data, the entropy-encoded optical flow flag encoded using a context that is selected based on which compound inter prediction mode of the plurality of compound inter prediction modes is used for the current block.

18. The non-transitory computer-readable storage medium of claim 17, wherein the context for encoding the optical flow flag for the current block is selected based on whether a compound inter prediction mode for the current block utilizes one or more motion vector differences.

19. The non-transitory computer-readable storage medium of claim 17, wherein the context for encoding the optical flow flag for the current block is selected based on how many motion vector differences are used for a compound inter prediction mode for the current block.

20. The non-transitory computer-readable storage medium of claim 17, wherein signaling of the optical flow flag is based on one or more of: (i) which compound inter prediction mode of the plurality of compound inter prediction modes is used for the current block, (ii) one or more properties of a reference frame for the current block, (iii) one or more inter prediction modes of neighboring blocks of the current block, and (iv) one or more reference frames of neighboring blocks of the current block.
